(19) United States
(12) Patent Application Publication
(10) Pub. No.: US 2025/0190948 A1
(43) Pub. Date: Jun. 12, 2025

(54) CANDIDATE SELECTION SYSTEM USING ARTIFICIAL INTELLIGENCE PROCESSING

(71) Applicant: SAP SE, Walldorf (DE)

(72) Inventors: Sachin B S, Bangalore (IN); Michele WYSS, Heidelberg (DE); Vidhya SHETTY, Heidelberg (DE)

(21) Appl. No.: 18/536,371

(22) Filed: Dec. 12, 2023

(51) Int. Cl. G06Q 10/1053; G06F 40/20

(52) U.S. Cl. CPC G06Q 10/1053; G06F 40/20

(57) ABSTRACT

System, method, and various embodiments for a candidate selection system are described herein. An embodiment operates by identifying a job description comprising qualifications for an individual who would be suitable for filling a job position corresponding to the job description. From a language model (LM), one or more mock candidates with that satisfy at least a subset of the qualifications are received. A similarity score between a set of resumes and the one or more mock candidates is generated. The set of resumes are ranked based on their respective similarity score, and a subset of the resumes with a highest similarity score are selected for the interviews for the position.

### BACKGROUND

Parsing through resumes to try and identify a candidate for a job opening is a manual and labor intensive process. Human resources departments often need to read through piles of resumes to identify qualified candidates, and even then, some qualified candidates may be missed. Searching electronic copies of the resumes for simple keywords from the job opening can be both time consuming and yield poor results, returning return resumes that include the keywords but the candidates may still be unqualified.

### BRIEF DESCRIPTION OF THE DRAWINGS

The accompanying drawings are incorporated herein and form a part of the specification.

FIG. 1 is a block diagram illustrating example functionality for a candidate selection system (CSS), according to some embodiments

FIG. 2 is a flowchart illustrating example operations for providing a candidate selection system (CSS), according to some embodiments.

FIG. 3 is example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a candidate selection system using artificial intelligence processing.

Parsing through resumes to try and identify a candidate for a job opening is a manual and labor intensive process. Human resources departments often need to read through piles of resumes to identify qualified candidates, and even then, some qualified candidates may be missed. Searching electronic copies of the resumes for simple keywords from the job opening can be both time consuming and yield poor results, returning return resumes that include the keywords but the candidates may still be unqualified.

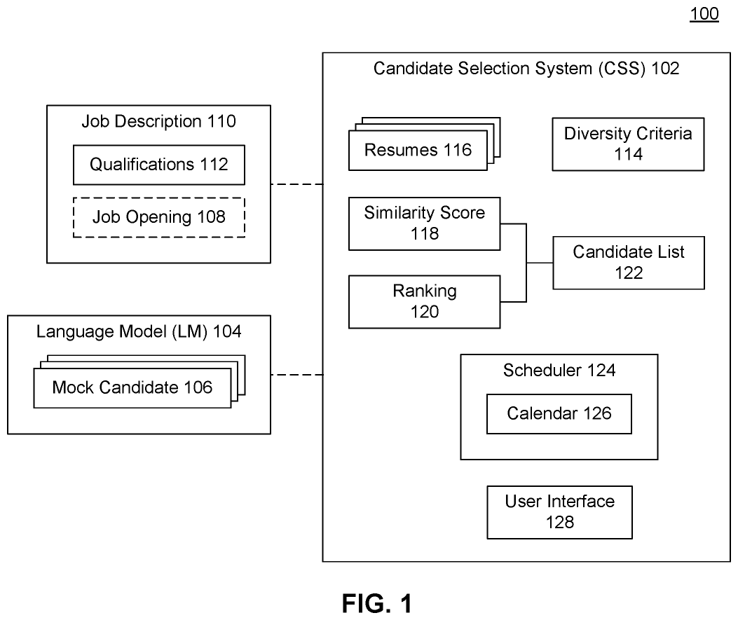

FIG. 1 is a block diagram 100 illustrating example functionality for a candidate selection system (CSS) 102, according to some embodiments. CSS 102 may expedite job searches and remove biases (both human and computer) that may otherwise prevent qualified candidates from being identified. In some embodiments, CSS 102 may generate or cause a language model (LM) 104 to generate a set of one or more mock candidates 106. These mock candidates 106 may serve as a basis for identifying real, human candidates to fill the job opening 108 as indicated by a corresponding job description 110. CSS 102 may also help protect the privacy of candidates and provide them with up-to-date job listings.

In some embodiments, an organization, such as a company, may have a job opening 108. The job opening 108 may include any position within the company, including paid, unpaid, contractor, employee, and volunteer positions. In some embodiments, job opening 108 may include multiple positions or slots to be filled. For example, the job opening 108 may be for a sales associate, however, the job opening 108 may also indicate that there are four open sales associate positions.

Job description 110 may include any description of the duties or requirements of a particular position of the job opening 108, which may include how many slots are open. The job description 110 may include roles, expectations, compensation, and/or responsibilities of a candidate who is desired for the job opening 108. For example, for a computer developer, the job description 110 may be: “You are a highly motivated individual. You will be working in a team with eight other developers building state-of-the-art computing systems. We are looking for a team player and a self-starter. You will be reporting directly to the CTO. Some travel may be required. You will be building programs in X and Y computing languages. Remote work is available 2 days per week.”

In some embodiments, job description 110 may include a list of qualifications 112 indicating requirements and/or preferences with regards to any candidates for the job opening 108. The qualifications 112 for a computer developer position may include, for example, undergraduate degree in computer science, certified in programming in X language, experience building network infrastructure, etc. In some embodiments, the qualifications 112 may include both required qualifications and preferred qualifications.

In some embodiments, CSS 102 may monitor the website of a company or organization for new job descriptions 110 or updated job descriptions 110. For example, CSS 102 may crawl or search the website of a particular company every day, or every week to identify new or updated job postings for which to generate mock candidates 106. Or, for example, CSS 102 may receive a notification from a server or the website each time a new job posting has been placed on the website.

In some embodiments, CSS 102 may track which job descriptions 110 were previously posted and/or processed, and thereby be able to identify new postings with new job descriptions 110. In some embodiments, the website may indicate when a job description 110 was updated or posted, and CSS 102 may compare the post/update time/date to the most recent scanning of the webpage to identify which new posting(s) if any are on the website.

Upon identifying a new or updated job posting on a website or portal corresponding to a job opening 108, CSS 102 may copy or retrieve the corresponding job description 110, identifying the preferences, requirements, or qualifications 112 from within the job description 110. CSS 102 may provide the job description 110 to language model (LM) 104 to generate a set of one or more mock candidates 106 for the job description 110.

LM 104 may include a pre-trained transformer or artificial intelligence system that is configured or designed to perform various tasks based on provided input or prompts. In some embodiments, LM 104 may be a large-scale language model (LLM). LLM may include a larger number of model parameters and more robust training data relative to a general LM.

While LM 104 may not require a particular format of input or prompt, in some embodiments CSS 102 may generate a prompt to be in a particular format that is easy for LM 104 to understand, process, and produces the desired output or results as described herein. In some embodiments, CSS 102 may generate a prompt template as a result of repeated trials and tests with data and output by LM 104, tweaked in a format that is used to produce the intended output. Though illustrated as being separate from CSS 102, in some embodiments, LM 104 may integrated within or with CSS 102, as part of one integrated computing system.

In some embodiments, LM 104 may be configured to read, process, and analyze a job description 104, and generate a set of mock candidates 106 whose mock qualifications would satisfy in the qualifications 112 in the job description 104. For simplicity, a single mock candidate 106 is illustrated in FIG. 1, however it is understood that LM 104 may generate any number of mock candidates 106, as such, the terms mock candidate 106 and mock candidates 106 may be used interchangeably.

In some embodiments, a user or CSS 102 may input how many mock candidates to generate and LM 104 may generate the appropriate number of mock candidates 106. In some embodiments, a user, via CSS 102, or CSS 102 may be configured to provide additional detail, instructions, or diversity criteria 114 to LM 104 which may create mock candidates 106 accordingly.

The diversity criteria 114 may include any information that may aid in generating the mock candidates 106. In some embodiments, diversity criteria 114 may specify diversity preferences, based on gender, years of experience, amount of schooling, which schools attended, certifications, type of experience, or any other legal diversity criteria. In some embodiments, the similarity score 118 of a first resume 116 satisfying the diversity criteria 114 is weighted more heavily than a second resume 116 that does not satisfy the diversity criteria 114. In some embodiments, the diversity criteria 114 includes multiple different elements, for example schooling and experience, each of which may be weighted differently. For example, experience may weighted more heavily than schooling. Then, for example, a resume 116 satisfying the experience criteria may be ranked higher than a resume satisfying the schooling criteria.

In an example of using diversity criteria 114, an engineering team may include 6 men and 2 women, and the diversity criteria 114 may specify a preference for a woman candidate. Or, for example, the diversity criteria 114 may request one candidate with 5 years of work experience and one candidate with less than 5 years of work experience. Or, for example, diversity criteria 114 may request only candidates with a specific certification or degree from a specific university. In some embodiments, diversity criteria 114 could specify negative attributes that are not preferred in a specific candidate, such no work experience after graduating (e.g., preferring new graduate candidates) or no undergraduate degree (e.g., preferring candidates who did not attend an undergraduate university or complete their undergraduate degree).

Based on the job description 110, qualifications 112, and diversity criteria 114, LM 104 may generate a set of one or more mock candidates 106. In some embodiments, the mock candidates 106 may be provided to a user (e.g., human resources department or hiring manager) for approval to ensure the mock candidates 106 would satisfy the criteria for the job opening 108. For example, CSS 102 may generate a user interface 128. User interface 128 may include the job description 110 and the corresponding set of mock candidates 106, which may be simultaneously viewable via user interface 128.

The user may then approve or reject any of the mock candidates 106 via user interface 128, and enter any new or additional diversity criteria 114. In some embodiments, if the user rejects a mock candidate 106, LM 104 may generate a new mock candidate 106 to replace the rejected candidate, in accordance with the new or additional diversity criteria 114 (if any). For example, a user may reject a mock candidate because “too much work experience”. Then, for example, CSS 102 may then generate or direct LM 104 to generate a new mock candidate with less work experience. Or, for example, the user may rejection a mock candidate 106 because its grade point average (GPA) is too low. CSS 102 may then generate or direct LM 104 to generate a new mock candidate with a higher GPA.

Once the user finalizes/approves the mock candidates 106, CSS 102 may parse resumes 116 for actual human candidates that are similar to the mock candidates 106. The resumes 116 may include electronic documents with information about various job candidates. The resumes 116 may include curriculum vitae and other information submitted by a candidate to a website, social media profiles of the candidates, or candidate information acquired from a website (e.g., posted employee information).

One of the advantages of using mock candidates 106 in addition to, or in lieu of, the job description 110 when parsing resumes 116, is that the mock candidates 106 provide greater specificity as to what the hiring manager or other user is actually looking for in a human candidate. The hiring manager or other user can approve the mock candidates 106 and then CSS 102 may more accurately identify which resumes 116 correspond to the those mock candidates 106. CSS 102 provides faster and more accurate results relative to doing a simple keyword search based on the job description 110, which cannot account for the context in which a keyword is used.

One advantage of generating multiple mock candidates 106 with different stated preferences is that this may help reduce or eliminate any computer or human bias that would otherwise be present if the resumes 116 were parsed through manually or by doing keyword searches. For example, a particular human resource user may have a subconscious bias to female candidates, or candidates that attended the same school as the human resource user. Or, for example, if a single mock candidate 106 is generated, the LM 104 may have a bias towards generating a male candidate. However, diversity criteria 114 may specify creating various candidates for different genders.

Another advantage of using mock candidates 106, is that LM 104 may be a publicly available artificial intelligence system. Requesting the generation of mock candidates 106 may help protect the privacy or identify of the individuals from whom resumes 116 were received (e.g., which would otherwise require submitting them to a the public system). In some embodiments, LM 104 may be, include, or incorporate features of a machine learning system.

In some embodiments, resumes 116 may include a first resume of a candidate who applied to a first job posting. The candidate may have not have been qualified for the posting, or the job opening 108 may have been filled by a different candidate. In some embodiments, CSS 102 may maintain the first resume on file. Then, CSS 102 may generate or cause LM 104 to generate a new set of mock candidates 106 for a new or updated second job description 110.

In some embodiments, CSS 102 may determine that the first resume for the candidate to the first job posting is a good candidate for this second job posting. For example, CSS 102 may determine that the similarity score 118 for the candidate and the mock candidates 106 for the second posting exceeds a threshold value. Then, for example, CSS 102 may notify the candidate in real-time (e.g., by using the contact information from resume 116) and request permission or authorization to submit the resume 116 of the candidate for this second job posting (e.g., which candidate did not previously apply for). This may provide the candidate with up-to-date job postings in real time, which could improve their odds of getting the position. For example, CSS 102 may send a text, email, or other electronic communication to the candidate. And upon receiving a positive authorization/response from the candidate, CSS 102 may submit the resume 116 for the candidate for consideration for the second position.

This may be beneficial for both candidate and potential employers because CSS 102 may automatically match qualified candidates to new job postings, in real-time, even without candidate specially applying to the new job postings, which could benefit both parties. In some embodiments, if additional information (e.g., such as a questionnaire or survey, etc.) is required from candidate, CSS 102 may collect this information from candidate upon receiving their positive authorization, or may alternative request this information at the same time as requesting authorization to apply for the second job.

In some embodiments, the candidate may authorize CSS 102 to automatically consider their resume 116 for any job postings or job openings 108, for which they may be qualified. Then for example, CSS 102 may send a notification to the candidate when their resume exceeds a threshold for a new position for which their resume 116 is being considered, or when an interview is to be scheduled.

In some embodiments, the CSS 102 may compare each resume 116 to each of the mock candidates 106 and generate a similarity score 118. For example, if there are two mock candidates 106, in some embodiments, CSS 102 may generate for each resume 116 three similarity scores 118. The first similarity score 118 may be a similarity of the resume to the first mock candidate, the second similarity score 118 may be a similarity of the resume to the second mock candidate, and the third similarity score 118 may be an aggregated similarity to all the mock candidates 106 and the job description 110. In some embodiments, the similarity score 118 may be a vector similarity score or measure.

CSS 102 may then generate one or more rankings 120. In some embodiments, ranking 120 may include a single ranking of all the resumes 116 in accordance of the aggregated or final similarity score 118. In other embodiments, the resumes 116 may be organized into two rankings, one for the first mock candidate 106 based on the first similarity score 118, and a second for the second mock candidate 106 based on the second similarity score 118. The ranking 120 may optionally include all three ranked lists.

In some embodiments, CSS 102 may generate a candidate list 122. Candidate list 122 may include the top five candidates for the job description 110 based on the similarity score 118, or any other number of top candidates. Or, for example, candidate list 122 may include any number of candidates who resumes exceed a threshold similarity score 118. In some embodiments, candidate list 122 may include multiple candidate lists 122 corresponding to each mock candidate 106 and/or the aggregated score. In some embodiments, a hiring manager may indicate the format of the candidate list 122 (e.g., how many candidates, one list or multiple lists, etc.).

In some embodiments, CSS 102 may automatically schedule interviews between the candidates corresponding to the resumes 116 in the candidate list 122 and a hiring manager or human resource professional. For example, a scheduler 124 may include access to the calendar 126 of one or more individuals who will be conducting an interview (phone, video call, or in person). Calendar 126 may include actual access to an electronic calendar, or an indication as to which dates/times the individual is available.

CSS 102 may extract contact information for the actual human candidates from their resumes 116 (e.g., which may include any other application forms or questionnaires or submitted materials). The contact information may include email address, phone number, social media handles, etc. Scheduler 124, may include an artificial intelligence or other computing system, that sends an electronic message to the candidates using the contact information to request an interview. Once the candidate agrees to a time that satisfies the calendar 126, CSS 102 may send a meeting request to both parties (e.g., which may include a copy of a resume 116 for the candidate and any other relevant materials).

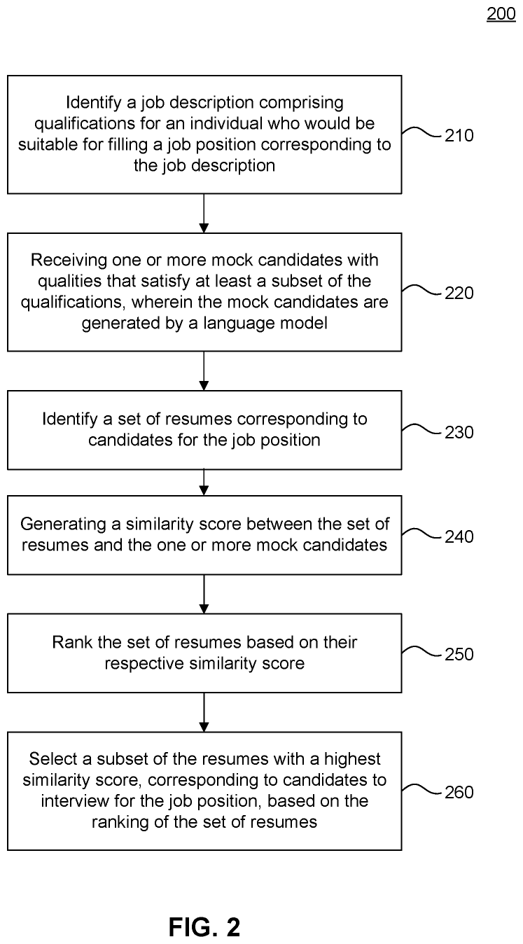

FIG. 2 is a flowchart 200 illustrating example operations for providing a candidate selection system (CSS) 102, according to some embodiments. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art. Method 200 shall be described with reference to FIG. 1.

In 210, a job description is identified, the job description including qualifications for an individual who would be suitable for filling a job position corresponding to the job description. For example, CSS 102 may be configured to periodically scan one or more websites for new job postings, and identify new job descriptions 110. The job descriptions 110 may include qualifications 112 for both required and preferences for the ideal candidate(s) for the job opening 108.

In 220, one or more mock candidates, generated by a language model, with qualities that satisfy at least a subset of the qualifications are received. For example, CSS 102 may provide the job description with diversity criteria 114 to a LM 104, which may generate a set of mock candidates 106 based on the job description 110 and any additional features or characteristics indicated by the diversity criteria 114.

In some embodiments, the mock candidates 106 may be displayed on a user interface 128 simultaneously with the job description 110 and/or qualifications 112, and a user may accept or reject the mock candidates 106. For any rejected mock candidates, LM 104 may generate a new one or more mock candidates 106 for the user to approve/select or reject. This process may be repeated until the user has a set of approved mock candidates 106.

In 230, a set of resumes corresponding to candidates for the job position are identified. For example, CSS 102 may have access to a set of resumes 116 or profiles for human candidates for the job opening 108. The resumes 116 may include resumes for this specific job opening 108 and/or resumes that were submitted for other job openings 108.

In 240, a similarity score between the set of resumes and the one or more mock candidates is generated. For example, CSS 102 may generate a similarity score 118 between each resume 116 and each mock candidate 106 and/or the set of mock candidates 106.

In 250, the set of resumes are ranked based on their respective similarity score. For example, CSS 102 may rank the resumes 116 from highest to lowest based on the similarity score 118.

In 260, a subset of the resumes with a highest similarity score, corresponding to candidates to interview for the job position, are selected based on the ranking of the set of resumes. For example, CSS 102 may select the top ten resumes 116 with the highest similarity score 118 and automatically schedule interviews between the candidates and one or more hiring mangers based on access to their availability/calendars 126. For example, CSS 102 may send a text or email message with a proposed date/time to a candidate, and if the candidate rejects the time, CSS 102 may send a new time. Once the candidate accepts a date/time, a meeting request may be generate for both the candidate and the hiring managers via text, email, automated phone all, or other electronic messaging.

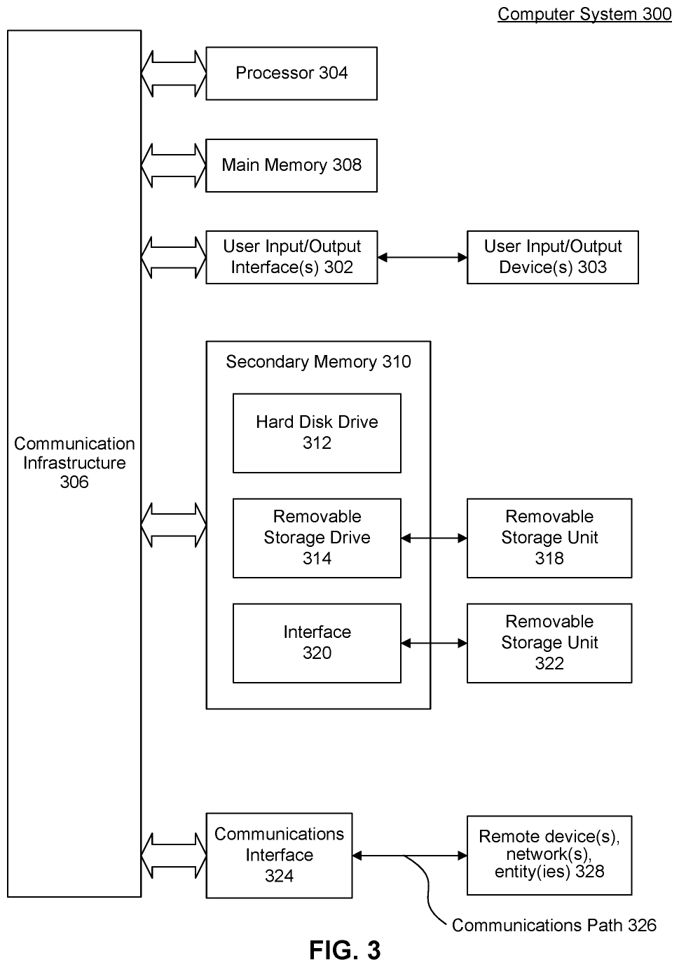

Various embodiments may be implemented, for example, using one or more well-known computer systems, such as computer system 300 shown in FIG. 3. One or more computer systems 300 may be used, for example, to implement any of the embodiments discussed herein, as well as combinations and sub-combinations thereof.

Computer system 300 may include one or more processors (also called central processing units, or CPUs), such as a processor 304. Processor 304 may be connected to a communication infrastructure or bus 306.

Computer system 300 may also include user input/output device(s) 303, such as monitors, keyboards, pointing devices, etc., which may communicate with communication infrastructure 306 through user input/output interface(s) 302.

One or more of processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 308 may include one or more levels of cache. Main memory 308 may have stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 may read from and/or write to removable storage unit 318.

Secondary memory 310 may include other means, devices, components, instrumentalities or other approaches for allowing computer programs and/or other instructions and/or data to be accessed by computer system 300. Such means, devices, components, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof), and which may include any combination of LANs, WANs, the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method comprising:
identifying a job description comprising qualifications for an individual who would be suitable for filling a job position corresponding to the job description;
receiving, from a language model (LM), one or more mock candidates that satisfy at least a subset of the qualifications, wherein the mock candidates are generated by the LM;
identifying a set of resumes corresponding to candidates for the job position;
generating, by one or more processors, a similarity score between the set of resumes and the one or more mock candidates;
ranking, by the one or more processors, the set of resumes based on their respective similarity score; and
selecting, by the one or more processors, a subset of the resumes with a highest similarity score, corresponding to candidates to interview for the job position, based on the ranking of the set of resumes.

2. The method of claim 1, wherein the generating the one or more mock candidates comprises:
identifying a set of diversity criteria for the one more candidates; and
generating a prompt for the LM, the prompt including both the job description and the set of diversity criteria, wherein the one or more candidates satisfy the diversity criteria.

3. The method of claim 1, wherein the generating the similarity score comprises:
identifying a set of diversity criteria for the one more candidates, wherein the similarity score of a first resume satisfying the diversity criteria is weighted more heavily than a second resume that does not satisfy the diversity criteria.

4. The method of claim 1, wherein the receiving comprises:
generating a prompt to request the one or more mock candidates from the LM; and
receiving the one or more mock candidates generated by the LM.

5. The method of claim 1, wherein the LM incorporates one of artificial intelligence or machine learning technologies in generating the one or more mock candidates.

6. The method of claim 1, further comprising:
identifying, by the one or more processors, availability for a hiring manager based on a calendar of the hiring manager;
identifying, by the one or more processors, contact information for the candidates corresponding to the subset of resumes with the highest similarity score; and
sending, by the one or more processors, electronic communications scheduling interviews between the candidates corresponding to the subset of resumes with the highest similarity score and the hiring manager.

7. The method of claim 1, wherein the identifying the job description comprises:
crawling a website;
identifying a new job opening posted to the website based on the crawling; and
retrieving the job description from the website.

8. A system comprising a memory and at least one processor coupled to the memory and configured to perform operations comprising:
identifying a job description comprising qualifications for an individual who would be suitable for filling a job position corresponding to the job description;
receiving, from a language model (LM), one or more mock candidates that satisfy at least a subset of the qualifications, wherein the mock candidates are generated by the LM;
identifying a set of resumes corresponding to candidates for the job position;
generating a similarity score between the set of resumes and the one or more mock candidates;
ranking the set of resumes based on their respective similarity score; and
selecting a subset of the resumes with a highest similarity score, corresponding to candidates to interview for the job position, based on the ranking of the set of resumes.

9. The system of claim 8, wherein the generating the one or more mock candidates comprises:
identifying a set of diversity criteria for the one more candidates; and
generating a prompt for the LM, the prompt including both the job description and the set of diversity criteria, wherein the one or more candidates satisfy the diversity criteria.

10. The system of claim 8, wherein the generating the similarity score comprises:
identifying a set of diversity criteria for the one more candidates, wherein the similarity score of a first resume satisfying the diversity criteria is weighted more heavily than a second resume that does not satisfy the diversity criteria.

11. The system of claim 8, wherein the receiving comprises:
generating a prompt to request the one or more mock candidates from the LM; and
receiving the one or more mock candidates generated by the LM.

12. The system of claim 8, wherein the LM incorporates one of artificial intelligence or machine learning technologies in generating the one or more mock candidates.

13. The system of claim 8, the operations further comprising:
identifying availability for a hiring manager based on a calendar of the hiring manager;
identifying contact information for the candidates corresponding to the subset of resumes with the highest similarity score; and
sending electronic communications scheduling interviews between the candidates corresponding to the subset of resumes with the highest similarity score and the hiring manager.

14. The system of claim 8, wherein the identifying the job description comprises:
crawling a website;
identifying a new job opening posted to the website based on the crawling; and
retrieving the job description from the website.

15. A non-transitory computer-readable medium having instructions stored thereon that, when executed by at least one computing device, cause the at least one computing device to perform operations comprising:
identifying a job description comprising qualifications for an individual who would be suitable for filling a job position corresponding to the job description;
receiving, from a language model (LM), one or more mock candidates that satisfy at least a subset of the qualifications, wherein the mock candidates are generated by the LM;
identifying a set of resumes corresponding to candidates for the job position;
generating a similarity score between the set of resumes and the one or more mock candidates;
ranking the set of resumes based on their respective similarity score; and
selecting a subset of the resumes with a highest similarity score, corresponding to candidates to interview for the job position, based on the ranking of the set of resumes.

16. The non-transitory computer-readable medium of claim 15, wherein the generating the one or more mock candidates comprises:
identifying a set of diversity criteria for the one more candidates; and
generating a prompt for the LM, the prompt including both the job description and the set of diversity criteria, wherein the one or more candidates satisfy the diversity criteria.

17. The non-transitory computer-readable medium of claim 15, wherein the generating the similarity score comprises:
identifying a set of diversity criteria for the one more candidates, wherein the similarity score of a first resume satisfying the diversity criteria is weighted more heavily than a second resume that does not satisfy the diversity criteria.

18. The non-transitory computer-readable medium of claim 15, wherein the receiving comprises:
generating a prompt to request the one or more mock candidates from the LM; and
receiving the one or more mock candidates generated by the LM.

19. The non-transitory computer-readable medium of claim 15, wherein the LM incorporates one of artificial intelligence or machine learning technologies in generating the one or more mock candidates.

20. The non-transitory computer-readable medium of claim 15, the operations further comprising:
identifying availability for a hiring manager based on a calendar of the hiring manager;
identifying contact information for the candidates corresponding to the subset of resumes with the highest similarity score; and
sending electronic communications scheduling interviews between the candidates corresponding to the subset of resumes with the highest similarity score and the hiring manager.
